(19) United States
(12) Patent Application Publication
(10) Pub. No.: US 2023/0399901 A1
(43) Pub. Date: Dec. 14, 2023

(54) WELLBORE FILTRATION SYSTEM AND METHOD FOR USING INVERSE PYRAMID COMPARTMENTS AND SUCTION PUMPS

(71) Applicant: Glenn Schulze, Brenham, TX (US)

(72) Inventor: Glenn Schulze, Brenham, TX (US)

(21) Appl. No.: 18/209,274

(22) Filed: Jun. 13, 2023

Related U.S. Application Data
(60) Provisional application No. 63/351,891, filed on Jun. 14, 2022.

(51) Int. Cl. E21B 21/06; E21B 43/34; B01D 21/00; B01D 21/26

(52) U.S. Cl. CPC E21B 21/066; E21B 43/35; B01D 21/0006; B01D 21/0018; B01D 21/262; B01D 2221/04

(57) ABSTRACT

A system and method are disclosed for separating solids from a slurry recovered from a hydrocarbon well. The system includes inverted pyramidal shaped compartments for settling solids downwardly within the liquid stream. Further, each compartment includes a desander pump and a desilter pump that draws solids from the partially cleaned slurry into a desander and desilter, respectively, for removal of solids from the stream. The system includes a network of Weir plates for directing cleaned slurry streams downstream through successive compartments.

### REFERENCE TO RELATED APPLICATIONS

This application claims the benefit of provisional patent application 63/351,891 filed Jun. 14, 2022, titled Wellbore Filtration System and Method for Using Inverse Pyramid Compartments and Suction Pumps, the entirety of which is incorporated herein by reference.

### BACKGROUND OF THE INVENTION

This invention relates generally to separation systems for separating solids from a fluid stream and, more particularly, to a system and method for separating solids from a slurry recovered from a hydrocarbon well that uses inverted pyramid settling compartments.

A wellbore is the actual hole that forms the well that is drilled to aid in the exploration and recovery of natural resources, including oil, gas, or water. When successful, the wellbore creates a well that can extract oil and gas for a protracted period of time. This extraction of oil and gas may use the process known as “fracking.” Drilling a wellbore, however, is complex and requires specialized training, tools, and equipment. At first, a slurry is advantageous in that the suspended solids within a semi-liquid water stream is useful for providing stability to the wellbore itself. A wellbore requires drilling through many layers of ground material, including mud, rock, water, minerals, and the like and results in a slurry that must be cleaned before its water can be used for other purposes and before the drilled materials may be recycled or disposed of. In addition, it is important clean the wellbore itself and that operating efficiency and cost is compromised when mud and debris is mixed with the oil or gas being extracted through the wellbore.

Various devices have been proposed in the art for separating solids from a slurry extracted or recovered from a hydrocarbon well. More particularly, proposed systems, such as the separating systems described in U.S. Pat. Nos. 10,751,654 and 11,040,300 disclose at least one tank having a V-shaped compartment with sloping sidewalls, a bottom, and a top. The systems further disclose a series of baffles positioned within the tank that cause a settling of solids within the slurry and then an auger operatively positioned on the bottom of the tank that is configured for rotation to cause the solids to be moved and eventually removed. The proposed systems may also include a linear shaker and other components for dewatering or moving a slurry.

Although presumably effective for their intended purposes, the settling of solids present in a slurry is slow and incomplete and their removal using an auger is inefficient and costly.

Therefore, it would be desirable to have a system for separating gas vapor and solids from a wellbore fluid stream that includes a first compartment having an inverted pyramid compartment that enhances a settling of solids from the fluid stream. Further, it would be desirable to have a system for separating gas vapor and solids from a wellbore fluid stream that includes a desander pump situated in fluid communication with the first compartment and configured to operatively suction the settling solids into a desander that produces a second slurry for direction into a second compartment. In addition, it would be desirable to have a system for separating gas vapor and solids from a wellbore fluid stream that includes a desilter pump situated in fluid communication with the second compartment and configured to operatively suction settling solids into a desilter that produces a third slurry for direction into a third compartment.

### SUMMARY OF THE INVENTION

Accordingly, a system for cleaning or purifying a slurry recovered from a wellbore includes a plurality of inverted pyramidal shaped compartments for settling solids downwardly within the liquid stream. Further, each compartment defines an outlet for receiving a portion of the slurry and through which a desander pump and a desilter pump draws solids from the partially cleaned slurry into a desander and desilter, respectively, for removal of solids from the stream. The system includes a network of Weir plates for directing cleaned slurry streams downstream through successive compartments. In fact, a slurry may be drawn through the desander and desilter multiple times until a predetermined amount of solids are removed from the water stream—removal of which is indicative that the slurry has been satisfactorily cleansed.

Therefore, a general object of this invention is to provide a system and method for separating solids from a slurry recovered from a hydrocarbon well.

Another object of this invention is to provide a system and method, as aforesaid, that uses inverted pyramid compartments for settling solids downwardly within the liquid stream.

Still another object of this invention is to provide a system and method, as aforesaid, that includes a desander pump that draws solids from the slurry into a desander for removal of sand from the stream.

Yet another object of this invention is to provide a system and method, as aforesaid, that includes a desilter pump that draws solids from the partially cleaned slurry into a desilter for removal of silt from the revised stream.

Still another object of this invention is to provide a system and method, as aforesaid, that includes a network of Weir plates positioned to direct the liquid stream through a plurality of cleaning compartments.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a system and method for separating solids from a slurry recovered from a hydrocarbon well according to a preferred embodiment of the present invention, illustrated mounted atop a flatbed trailer;

FIG. 2 is a side view of the system as in FIG. 1;

FIG. 3a is a right end view of the system as in FIG. 1;

FIG. 3b is a sectional view taken along line 3b-3b of FIG. 3a; and

FIG. 4 is a flow diagram schematically illustrating the flow of a slurry stream according to the present invention.

### DESCRIPTION OF THE PREFERRED EMBODIMENT

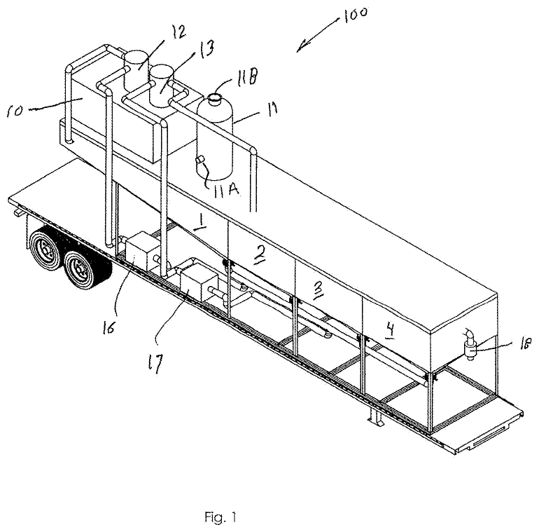

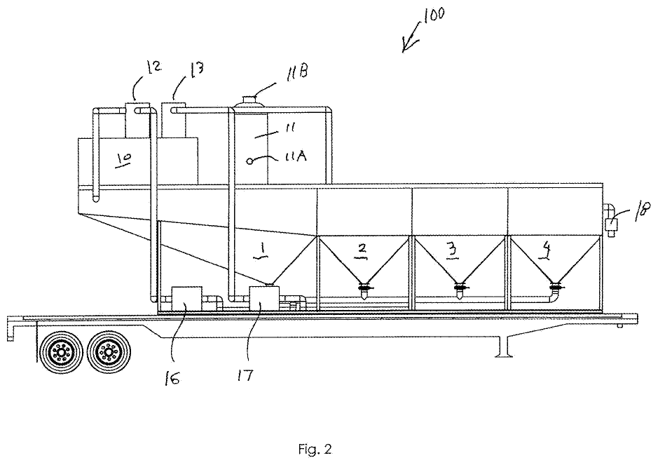

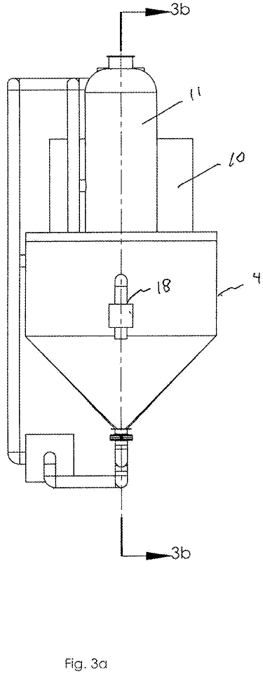

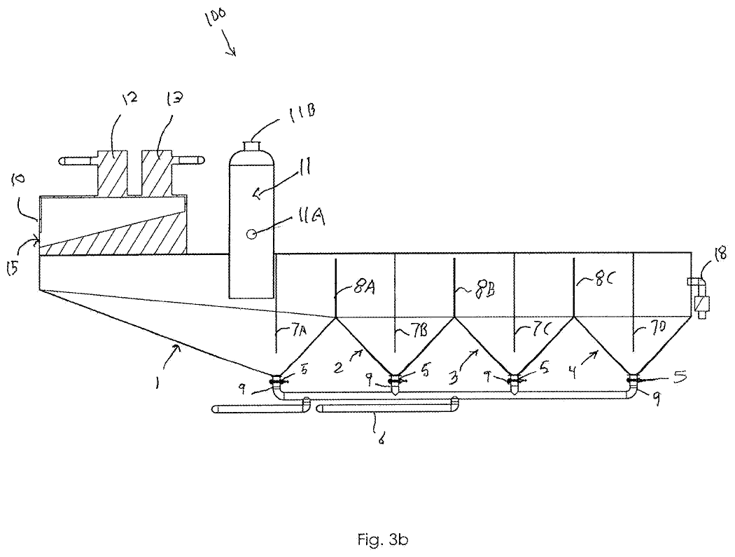

A system and method for separating solids from a slurry recovered from a hydrocarbon well according to a preferred embodiment of the present invention will now be described with reference to FIGS. 1 to 4 of the accompanying drawings.

The term slurry is used in a variety of fields to refer to a combination of solids with liquid. Sometimes, the semi-liquid mixture could have different degrees of thickness depending on the application. The use of a slurry allows for the rapid movement of solid particles during the excavation process, and it is useful in applying pressure to stabilize a borehole. In the end, however, it may become desirable to clean cleanse the slurry so as to remove the previously advantageous suspended or solid particles such that the cleansed water stream may be used for other purposes.

A wellbore fluid stream (also referred to as a slurry or “mud”) may be initially introduced into the system 100 via a separator 11. An oil and gas separator is a vessel that is used for separating the fluid components of an oil and gas well stream into both gaseous and liquid constituents. Gaseous elements may be directed to a stack 11B for burning or venting to the atmosphere. Solids and liquids may be directed from the separator 11 via an inlet 11A for cleaning as will described below and then into compartment 1 as will be described below.

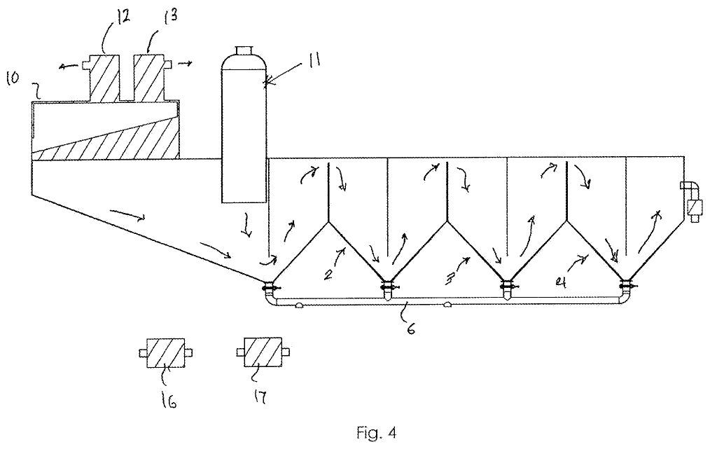

The system 100 includes a framework comprised of a plurality of cleaning compartments coupled together in downstream succession, each compartment having a defined structure and role to play in the method for cleaning a water stream, also referred to as a slurry, taken from a wellbore. Preferably, each compartment may be constructed of sheet metal having an inverted pyramidal shape configuration. More particularly, each compartment may include V-shaped walls that, together, define an opening or bottom outlet through which solids having settled out of the water stream are urged out of the stream and out of the compartment, respectively. For clarity in the description, the compartments are labeled 1, 2, 3, and 4. Further and as shown in FIG. 4, each compartment includes a downward directional Weir plate that is positioned adjacent an associated bottom outlet and configured to direct solids settling out of a slurry stream toward a respective pump positioned adjacent a respective outlet such that a portion of the slurry heavily dense with solids is pumped out, as will be further described later. The downward directional Weir plates are labeled 7A, 7B, 7C, and 7D, each downward directional Weir plate being coupled to an upper end of the housing frame and extending downwardly so as to partition or divide each compartment into a first chamber characterized by a slurry flow that is settling and directed downwardly toward an outlet and pump, respectively, and a second chamber characterized by a slurry flow that is generally flowing upwardly toward entry into a next adjacent cleaning compartment, respectively. Similarly, each compartment includes an upward directional Weir plate that is open adjacent an upper end of a respective compartment and configured to direct the slurry stream from a current compartment to an adjacent downstream compartment. The upward directional Weir plates are labeled 8A, 8B, 8C, and 8D. Directional arrows are included in FIG. 4a to illustrate the intended and actual flow of the slurry as described above. As implied and shown, it will be understood that portions of the slurry may be repeatedly pumped out and cleaned and returned to the slurry flow until sufficiently cleaned so as to flow to a next adjacent cleaning container and, eventually, completely through the system 100.

In a related aspect, each bottom outlet may include a 6″ butterfly valve 5 and a 6″ tee 9 and is in fluid communication with a conduit which will be referred to as a suction line 6. The suction line 6 is in fluid communication with the desander pump 16 or the desilter pump 17, respectively, as will be discussed in greater detail later. Both pumps may be referred to as centrifugal pumps.

In another aspect, the system 100 includes equipment for separating solids out of a wellbore fluid stream, including a shaker 10, a desander 12, and a desilter 13. Desanders and desilters are solid control equipment with a set of hydrocyclones that separate sand and silt from the drilling fluids in a wellbore. Each may use centrifugal movement to separate liquid and solid aspects of the stream. The desander 12 is in fluid communication with the desander pump 16 and the desilter 13 is in fluid communication with the desilter pump 17, such as with conduit in fluid communication with a respective outlet of a respective cleaning container. Preferably, each conduit passes through the desander 12 or desilter 13, respectively, and then the revised outflow is discharged onto the shaker 10 to remove large solids (cuttings) from the drilling fluid (a.k.a. “mud”), removal being via a solids trough 15. Removal of the largest solids via the shaker 10 is important so that successively smaller solid elements can be successively removed by the desander 12 and desilter 13, and so that downstream equipment remains clean.

A method for filtration of a wellbore slurry will now be disclosed with reference to the components of the system 100 described above. Fluid flow is shown via arrows in FIG. 4. A dirty fluid stream (a.k.a. a slurry for “mud”) from an oil or gas wellbore is directed via an inlet 11A into the separator 11 where its gaseous elements are separated from its liquid and gas elements. The gaseous elements may be directed to a flare stack 11B where it is burned or vented while the liquid and solids suspended therein are directed into a first compartment 1 to begin a cleaning process. First, solid components of the fluid stream are actively directed downwardly by the V-shaped sidewalls and inverse pyramidal shape configuration of the first compartment 1. More so, solid components of the fluid stream are suctioned downwardly by electrical operation of the desander pump 16. Accordingly, the slurry is pulled into and then pushed through a cleaning container outlet and then via a conduit, into the desander 12 where a centrifugal action may further remove sand from the stream and then the outflow is discharged onto into the shaker 10 where larger diameter solids may be removed and isolated or disposed of via trough 15. The first revised/remediated fluid stream may then be directed back into compartment 1 where it is again directed downwardly toward by the inverted pyramidal sidewalls and the urging of the desander pump 16. Additional solid materials may be again transported by the desander pump 16 to the desander 12 for additional cleaning whereas the second revised fluid stream that is devoid of solids is allowed to flow beneath Weir plate 7A into a second compartment 2.

As shown, the second revised fluid stream is allowed to flow up and over Weir plate 8A where it is immediately drawn downwardly along V-shaped walls of the inverted pyramidal shaped compartment 2 and as downwardly suction by electrical operation of the desilter pump 17. The desilter pump 17, via a respective conduit, is configured to direct the collected slurry through the desilter 13 where silt may be centrifugally removed and the outflow is discharged onto the shaker 10. Now thrice revised, the revised fluid stream may be directed, such as by conduit, back into the second compartment 2 to where solids may again be separated out as described above while the clean liquid is directed under Weir plate 7B then over Weir plate 8B and into compartment 3.

Compartment 3 also defines an outlet or valve 9 that is still under the suction influence of the desilter pump 17 such that the fluid stream may be further cleaned as necessary while clean liquid is directed under Weir plate 7C then over Weir plate 8C and into compartment 4. Compartment 4 also defines an outlet or valve 9 that is still under the suction influence of the desilter pump 17 such that the fluid stream may be further cleaned as necessary while clean liquid is directed under Weir plate 7D then over Weir plate 8D and through an outlet 18.

It is understood that while certain forms of this invention have been illustrated and described, it is not limited thereto except insofar as such limitations are included in the following claims and allowable functional equivalents thereof.

1. A system for separating solids from semi-liquid water stream recovered from a hydrocarbon well, comprising:
an inlet configured to receive a slurry;
a plurality of cleaning compartments in fluid communication with said inlet that are coupled together in downstream succession, each cleaning compartment having an inverted pyramidal configuration with a plurality of V-shaped walls defining an interior area and that terminate at an outlet and that is operable for downward settling of the solids from the slurry;
a desander device displaced from and in fluid communication with said plurality of cleaning compartments via a desander conduit, said desander device having a desander pump that is operable to suction the slurry downwardly toward said outlet of a respective cleaning compartment when energized so as to extract a portion of the slurry,
said desander device being configured to remove sand from said extracted portion so as to generate a first cleaned slurry, said desander device being in fluid communication with plurality of cleaning compartments and configured to deposit said first cleaned slurry into a first cleaning compartment of said plurality of cleaning compartments.

2. The system as in claim 1, wherein said plurality of cleaning compartments each includes an upward directional Weir plate having (1) a lower section that is closed so as to block a remainder portion of the slurry that was not extracted from the slurry from flowing into the interior area of a next downstream cleaning compartment and having (2) an upper section that is open so as to allow the remainder portion of the slurry to flow into the interior area of the next downstream cleaning compartment.

3. The system as in claim 2, further comprising:
a desilter device displaced from but in fluid communication with said next downstream cleaning compartment via a desilter conduit, said desilter device having a desilter pump that is operable to suction a respective slurry portion downwardly toward an outlet of said next downstream cleaning compartment when energized so as to extract a portion of the respective slurry portion,
said desilter device being configured to remove salt from said extracted portion so as to generate a second cleaned slurry, said desilter device being in fluid communication with said plurality of cleaning compartments and configured to deposit said second cleaned slurry into said first cleaning compartment of the plurality of cleaning compartments.

4. The system as in claim 1, further comprising a shaker upstream of said plurality of cleaning compartments and in fluid communication with said inlet so as to receive said slurry, said shaker being configured to vent or burn a gaseous portion of said slurry and to deposit a liquid portion of said slurry into said plurality of cleaning compartments.

5. The system as in claim 2, wherein:
each said lower section of a respective upward directional Weir plate is coupled to a bottom wall of a respective cleaning compartment such that the lower section of said Weir plate blocks said remainder portion of the slurry, respectively; and
each said upper section of said respective upward directional Weir plate is displaced from an upper wall of said respective cleaning compartment such that the upper section of said Weir plate, respectively, allows said remainder portion of the slurry to flow downstream into said next downstream cleaning compartment.

6. The system as in claim 5, wherein said plurality of cleaning compartments each includes a downward directional Weir plate each having (1) an upper section that is closed so as to block a remainder portion of the slurry that was not extracted from the slurry from flowing into the interior area of a next downstream cleaning compartment and having (2) a lower section that is open so as to allow the remainder portion of the slurry to flow downstream toward a respective outlet of a respective cleaning compartment.

7. The system as in claim 6, wherein each downward directional Weir plate is coupled to an upper edge of a respective cleaning compartment and extends downwardly so as to partition each cleaning compartment into (1) a first chamber in which a slurry flow is directed downwardly toward a respective outlet, and (2) a second chamber in which the slurry flow is generally flowing upwardly toward entry into said next adjacent cleaning compartment, respectively.

8. A system for eliminating impurities from a slurry taken from a hydrocarbon wellbore, comprising:
an inlet configured to receive the slurry;
a plurality of cleaning compartments in fluid communication with said inlet that are coupled together in downstream succession, each cleaning compartment having an inverted pyramidal configuration with a plurality of V-shaped walls defining an interior area and that terminate at an outlet and that is operable for downward settling of the solids from the slurry,
each cleaning compartment including an upward directional Weir plate having (1) a lower section that is closed so as to block a remainder portion of the slurry that was not extracted from the slurry from flowing into the interior area of a next downstream cleaning compartment and having (2) an upper section that is open so as to allow the remainder portion of the slurry to flow into the interior area of the next downstream cleaning compartment, and
each cleaning compartment including a downward directional Weir plate each having (1) an upper section that is closed so as to block a remainder portion of the slurry that was not extracted from the slurry from flowing into the interior area of a next downstream cleaning compartment and having (2) a lower section that is open so as to allow the remainder portion of the slurry to flow downstream toward a respective outlet of a respective cleaning compartment.

9. The system as in claim 8, further comprising:
a desander device displaced from and in fluid communication with said plurality of cleaning compartments via a desander conduit, said desander device having a desander pump that is operable to suction the slurry downwardly toward said outlet of a respective cleaning compartment when energized so as to extract a portion of the slurry;
wherein said desander device is configured to remove sand from said extracted portion so as to generate a first cleaned slurry, said desander device being in fluid communication with plurality of cleaning compartments and configured to deposit said first cleaned slurry into a first cleaning compartment of said plurality of cleaning compartments.

10. The system as in claim 9, further comprising:
a desilter device displaced from but in fluid communication with said next downstream cleaning compartment via a desilter conduit, said desilter device having a desilter pump that is operable to suction a respective slurry portion downwardly toward an outlet of said next downstream cleaning compartment when energized so as to extract a portion of the respective slurry portion;
wherein said desilter device is configured to remove salt from said extracted portion so as to generate a second cleaned slurry, said desilter device being in fluid communication with said plurality of cleaning compartments and configured to deposit said second cleaned slurry into said first cleaning compartment of the plurality of cleaning compartments.

11. The system as in claim 8, further comprising a shaker upstream of said plurality of cleaning compartments and in fluid communication with said inlet so as to receive said slurry, said shaker being configured to vent or burn a gaseous portion of said slurry and to deposit a liquid portion of said slurry into said plurality of cleaning compartments.

12. The system as in claim 8, wherein:
each said lower section of a respective upward directional Weir plate is coupled to a bottom wall of a respective cleaning compartment such that the lower section of said Weir plate blocks said remainder portion of the slurry, respectively; and
each said upper section of said respective upward directional Weir plate is displaced from an upper wall of said respective cleaning compartment such that the upper section of said Weir plate, respectively, allows said remainder portion of the slurry to flow downstream into said next downstream cleaning compartment.

13. The system as in claim 12, wherein each downward directional Weir plate is coupled to an upper edge of a respective cleaning compartment and extends downwardly so as to partition each cleaning compartment into (1) a first chamber in which a slurry flow is directed downwardly toward a respective outlet, and (2) a second chamber in which the slurry flow is generally flowing upwardly toward entry into said next adjacent cleaning compartment, respectively.

14. A system for separating solids from semi-liquid water stream recovered from a hydrocarbon well, comprising:
an inlet configured to receive a slurry;
a plurality of cleaning compartments in fluid communication with said inlet that are coupled together in downstream succession, each cleaning compartment having an inverted pyramidal configuration with a plurality of V-shaped walls defining an interior area and that terminate at an outlet and that is operable for downward settling of the solids from the slurry;
a desander device displaced from and in fluid communication with said plurality of cleaning compartments via a desander conduit, said desander device having a desander pump that is operable to suction the slurry downwardly toward said outlet of a respective cleaning compartment when energized so as to extract a portion of the slurry;
a desilter device displaced from but in fluid communication with said next downstream cleaning compartment via a desilter conduit, said desilter device having a desilter pump that is operable to suction a respective slurry portion downwardly toward an outlet of said next downstream cleaning compartment when energized so as to extract a portion of the respective slurry portion;
wherein each cleaning compartment includes an upward directional Weir plate having (1) a lower section that is closed so as to block a remainder portion of the slurry that was not extracted from the slurry from flowing into the interior area of a next downstream cleaning compartment and having (2) an upper section that is open so as to allow the remainder portion of the slurry to flow into the interior area of the next downstream cleaning compartment, and
wherein each cleaning includes including a downward directional Weir plate each having (1) an upper section that is closed so as to block a remainder portion of the slurry that was not extracted from the slurry from flowing into the interior area of a next downstream cleaning compartment and having (2) a lower section that is open so as to allow the remainder portion of the slurry to flow downstream toward a respective outlet of a respective cleaning compartment.

15. The system as in claim 14, wherein:
said desander device is configured to remove sand from said extracted portion so as to generate a first cleaned slurry, said desander device being in fluid communication with plurality of cleaning compartments and configured to deposit said first cleaned slurry into a first cleaning compartment of said plurality of cleaning compartments; and
said desilter device is configured to remove salt from said extracted portion so as to generate a second cleaned slurry, said desilter device being in fluid communication with said plurality of cleaning compartments and configured to deposit said second cleaned slurry into said first cleaning compartment of the plurality of cleaning compartments.

16. The system as in claim 14, further comprising a shaker upstream of said plurality of cleaning compartments and in fluid communication with said inlet so as to receive said slurry, said shaker being configured to vent or burn a gaseous portion of said slurry and to deposit a liquid portion of said slurry into said plurality of cleaning compartments.
